(19) United States
(12) Patent Application Publication
(10) Pub. No.: US 2025/0153109 A1
(43) Pub. Date: May 15, 2025

(54) HIGH-TEMPERATURE SPIRAL-WOUND MODULE MADE OF METAL COMPONENTS

(71) Applicant: Evonik Operations GmbH, Essen (DE)

(72) Inventors: Bastian Matthias Brugger, Duisburg (DE); Marc Lochthove, Marl (DE); Christian Gehring, Marl (DE); Michael Kube, Haltern am See (DE); Meike Dahlhues, Marl (DE)

(73) Assignee: Evonik Operations GmbH, Essen (DE)

(21) Appl. No.: 18/838,659

(22) PCT Filed: Feb. 16, 2023
(86) PCT No.: PCT/EP2023/053867

§ 371 Date: Aug. 15, 2024

(30) Foreign Application Priority Data
Feb. 21, 2022 (DE) 20 202 2000 423.0

(51) Int. Cl. B01D 63/10

(52) U.S. Cl. CPC B01D 63/106; B01D 63/107

(57) ABSTRACT

A spiral-wound module as a type of a membrane is made of at least a metallic, hollow cylindrical permeate tube, a two-dimensional rectangular membrane wound in a spiral wound around the permeate tube, two axial stops fitted to the permeate tube on either side of the spiral winding and a metallic, hollow cylindrical outer tube extending the outer limits of the permeate tube.

The invention relates to a spiral-wound module comprising at least the following components:
a) a metallic, hollow cylindrical permeate tube, in the wall of which there are openings that extend radially;
b) an essentially two-dimensional rectangular membrane wound in a spiral around the permeate tube, which forms an essentially cylindrical spiral winding that extends coaxially to the permeate tube;
c) two axial stops (anti-telescoping devices ATD) that are fitted to the permeate tube on either side of the spiral winding and each abut the respective end face of the spiral winding, where the axial stops are provided with axially fluid-permeable passages;
d) a metallic, hollow cylindrical outer tube that extends coaxially with respect to the permeate tube, surrounds the spiral winding and is joined to the two axial stops.

Membranes serve to separate liquid or gaseous mixtures of matter. They are used in chemical engineering, food technology and medical technology. The membranes are generally not installed separately into the corresponding separation apparatus, but rather in the form of a membrane module. A membrane module is an assembly that contains one or more membranes and is intended for use in a separation apparatus. A particular design of a membrane module is what is called a spiral-wound module. In a spiral-wound module, an essentially two-dimensional rectangular membrane is wound in a spiral around a tube. In this way, a large membrane area is accommodated in a small construction size of the module. The spiral winding is fed with the mixture of matter to be separated (the feed) from an end face. The portion of the mixture of matter that passes through the membrane (the permeate) passes through holes into the central tube and is thus removed from the module. The tube is therefore also referred to as permeate tube. The portion of the mixture of matter that does not pass through the membrane (the retentate) leaves the module via the other end face of the spiral winding.

The fundamentals of membrane technology and also the design of membrane modules are outlined by:
Thomas Melin; Robert Rautenbach: Membranverfahren: Grundlagen der Modul-und Anlagenauslegung [Membrane Processes. Fundamentals of Module and System Design]. 2nd edition 2004. Springer Berlin Heidelberg 2004 DOI 10.1007/978-3-662-08653-7

A spiral-wound module of the type specified at the outset is known from EP 3328521 B1. More specifically, EP 3328521 B1 describes a cartridge for use in a separation apparatus, which can be equipped either with a spiral-wound module or with a hollow fibre module. This flexibility is at the cost of a comparatively complicated construction that has disadvantages under harsh conditions. Especially in the separation of liquid mixtures at high temperatures, the plastics installed are subject to high stress, and so the lifetime can be assumed to be short. In a region of sustained use, meanwhile, only low operating temperatures below 120° C. can be achieved. This is especially true with regard to the barrier, which prevents flooding of the membrane winding. This barrier, in the wound membrane module described in EP 3328521 B1, is executed as a shrink-fit tube, especially made of polyolefin, PVC or polyimides. The shrink-fit tube is shrunk onto the membrane winding. At relatively high separation temperatures, the shrink-fit tube expands again, such that the barrier can no longer fulfil its function as flooding protection.

A spiral-wound module for high pressures is known from CN 111450709 A1. The axial stops (anti-telescoping devices, ATDs) are not fitted to the permeate tube, but rather press-fitted to the permeate tube at the end face with the aid of a bolt that runs centrally within the permeate tube. The resultant assembly composed of permeate tube, membrane winding, ATDs and bolt is inserted into an outer tube and safeguarded against axial movement in the outer tube by retaining rings. This construction comprises very many components and is very difficult to assemble. This increases production costs. This might be justified within the scope of a high-pressure application, but not in the case of high temperatures and low pressures.

The object of the invention was therefore to specify a spiral-wound module which is usable at high operating temperatures preferably exceeding 150° C. and has a simple, robust and inexpensive construction.

This object is achieved in that at least one of the two axial stops has a sleeve-shaped extension which, at its circumference, is surrounded by the outer tube such that a force-fitting and/or form-fitting connection is implemented between the outer tube and the axial stop via the extension thereof.

The invention therefore provides a spiral-wound module comprising at least the following components:
a) a metallic, hollow cylindrical permeate tube, in the wall of which there are openings that extend radially;
b) an essentially two-dimensional rectangular membrane wound in a spiral around the permeate tube, which forms an essentially cylindrical spiral winding that extends coaxially to the permeate tube;
c) two axial stops (anti-telescoping devices ATD) that are fitted to the permeate tube on either side of the spiral winding and each abut the respective end face of the spiral winding, where the axial stops are provided with axially fluid-permeable passages and where at least one of the two axial stops has a sleeve-shaped extension,
d) a metallic, hollow cylindrical outer tube that extends coaxially with respect the permeate tube, surrounds the spiral winding and is joined to the two axial stops, where a force-fitting and/or form-fitting connection between the outer tube an the axial stop with the extension is achieved in that the sleeve-shaped extension is surrounded by the outer tube at its circumference.

The invention will now be illustrated by working examples. For this purpose, the figures show:

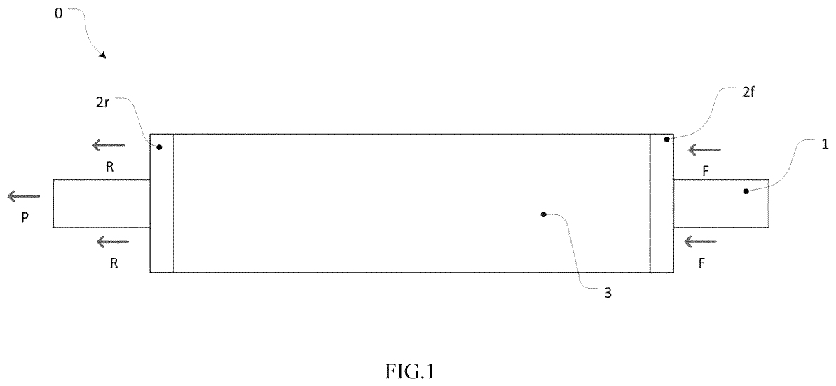

FIG. 1 spiral-wound module, full view;

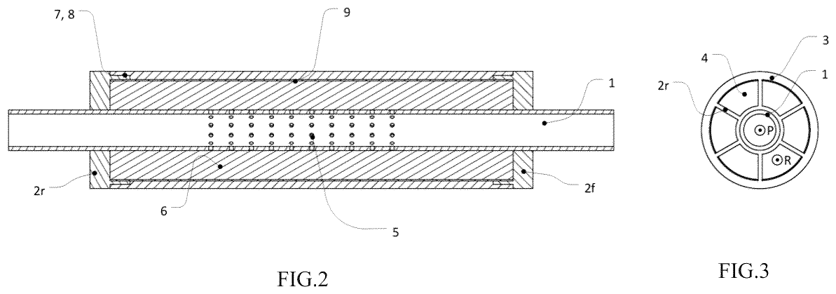

FIG. 2 spiral-wound module, sectional diagram,

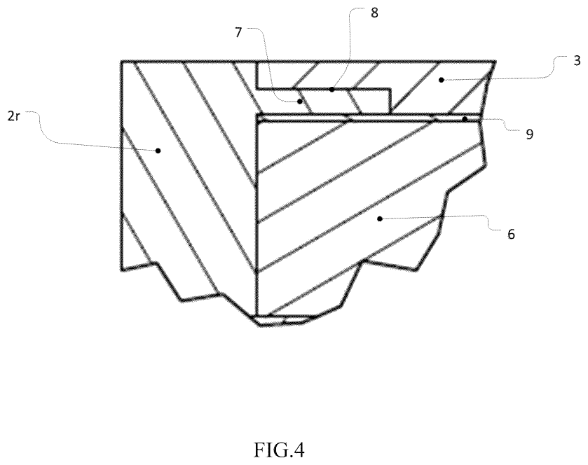

FIG. 3 spiral-wound module, end view;

FIG. 4 detail enlargement of the connection between axial stop and outer tube.

FIG. 1 shows a full view of the spiral-wound module 0. What can be seen is a central permeate tube 1 on which two axial stops 2f, 2r are fitted. The first axial stop 2f is disposed on the feed side, the second axial stop 2r on the retentate side. The two axial stops 2f, 2r are connected to one another via an outer tube 3.

The feed F flows through the first axial stop 2f into the spiral-wound module 0. The permeate P exits the spiral-wound module 0 again through the permeate tube 1. The retentate R exits the spiral-wound module 0 via the second axial stop 2r.

In order to enable the passage of the feed F or retentate R through the axial stops 2f, 2r, these are provided with multiple generous passages 4. The passages 4 can be seen only in FIG. 3.

The exact construction of the spiral-wound module 0 is apparent from the sectional diagram in FIG. 2. The permeate tube 1 extends centrally. It is hollow-cylindrical and consists of steel. The wall of the permeate tube 1 is provided with a multitude of openings 5 that radially permeate the wall.

A spiral winding 6 is wound around the permeate tube 1. The spiral winding arises from winding of an essentially flat rectangular membrane in a spiral around the permeate tube 1. The two-dimensional membrane thus gives rise to an essentially cylindrical spiral winding that extends along the permeate tube 1. It is also possible for a spacer (not shown) to be wound into the spiral winding 6, which ensures that the individual windings of the spirals do not directly adjoin one another.

In order that the spiral winding 6 does not telescope axially under load, it is abutted at each end face by the axial stops 2f, 2r. The axial stops 2f, 2r adjoin the spiral winding 6 at the end face and are fitted onto the permeate tube 1. In this way, the axial stops 2f, 2r transmit forces between the spiral winding 6 and the permeate tube 1. The position of the axial stops 2r, 2f relative to the permeate tube 1 defines the axial position of the spiral winding 1 and especially prevents telescoping. The axial stops are therefore also referred to as anti-telescoping devices ATDs.

What cannot be seen in FIG. 2 is that the ATDs 2r, 2f have a multitude of passage openings 4 of large area in segment-like shapes, through which the feed F or retentate R can pass. The passage openings 4 can be seen only in the side view of FIG. 3. The axial stops are formed as lands between the passage openings 4. The lands are in the section plane in FIG. 2.

At least one of the two axial stops has a sleeve-shaped extension 7 on the inside. In the present working example, this goes for both axial stops 2r, 2f. With their respective extension 7, the axial stops are each inserted into a corresponding seat on the inside of the outer tube 3.

At the contact site between the sleeve-shaped extension 7 and the corresponding seat in the outer tube 3, a force-fitting and/or form-fitting connection 8 is achieved, which joins the axial stop provided with the extension 7 to the outer tube 3.

A useful force-fitting and/or form-fitting connection 8 is either a press-fit connection or a screw connection.

In the case of a press-fit connection, the extension 7 is cylindrical at its circumference. The seat is likewise cylindrical. The outer diameter of the extension 7 and the inner diameter of the seat are then such that a press fit is formed between the extension 7 and the seat, which forms the press-fit connection.

In the case of a screw connection, the extension 7 is provided with an external thread at its circumference. The seat takes the form of an internal thread. The extension 7 is screwed into the internal thread by its outer thread. In this way, a screw connection is achieved between the axial stop 2r, 2f provided with the extension 7 and the outer tube 3.

In both ways, a force fit is possible between outer tube 2 and axial stops 2r, 2f. The permeate tube 1 is likewise centred in the outer tube. The periphery of the outer tube 1 serves as contact surface with the separation apparatus (not shown here), into which the spiral-wound module 0 is inserted. It is possible to dispense with any seal between the periphery of the outer tube and the contact surface of the separation apparatus because the spiral-wound module 0 is intrinsically leak-tight. The sealing concept is described further down.

In operation, the feed F flows through the passages in the feed-side axial stop 2f into the spiral winding 6. The permeate passes through the membrane, and flows inward and through the openings 5 into the permeate tube 1. The permeate P leaves the spiral-wound module through the permeate tube 1. The portion of the feed that cannot pass through the membrane leaves the spiral-wound module 6 as retentate R through the passage openings 6 in the retentate-side axial stop 2r.

In a preferred concept of the invention, the spiral-wound module 0, within the outer tube 3, has a foil 9 that seals the spiral winding on the outside. This prevents flooding of the membrane winding 6 with inadequate occurrence of permeate.

The foil 9 preferably consists of metal or another thermally stable material. Especially useful are foils made of a metal alloy, for example steel, aluminium alloy or copper alloy. Likewise usable are thermally stable polymers, for example polyimide. It is important that the foil is made of a material having sustained stability at operating temperature.

The foil 9 is rectangular and wound tight around the spiral winding 6. The winding angle of the foil 9 is between 360° and 400°, such that the foil 9 forms an overlap region of 0° to 40°. The foil 9 is apparent especially in the enlarged detail of FIG. 4. In the overlap region, the foil 9 is bonded to itself by a layer of a thermally stable adhesive/sealant. The layer is sufficiently thin that it cannot be seen even in the enlargement of FIG. 4.

The seal concept envisages that the sleeve-shaped extension 7 is bonded on its inside either to the spiral winding 1 or—if present—to the foil 9, in order to seal the spiral-wound module 0 from the outside. A thermally stable adhesive/sealant is used for bonding, which is also used to bond the spiral winding 1 and/or the foil.

In that case, the force- and/or form-fitting connection 8 need not be sealed.

List of reference symbols

| F | feed | |
|---|---|---|
| P | permeate | |
| R | retentate | |
| 0 | spiral-wound module | |
| 1 | permeate tube | |
| 2f | axial stop | on the feed side |
| 2r | axial stop | on the retentate side |

| | |
|---|---|
| 3 | outer tube |
| 4 | passage |
| 5 | openings |
| 6 | spiral winding |
| 7 | extension |
| 8 | force- and/or form-fitting connection |
| 9 | foil |

1-8. (canceled)

9. A spiral-wound module, comprising at least the following components:
a metallic, hollow cylindrical permeate tube, the tube having a wall with radially-extending openings;
an essentially two-dimensional rectangular membrane wound in a spiral around the permeate tube, which forms an essentially cylindrical spiral winding that extends coaxially to the permeate tube;
two axial stops (anti-telescoping devices ATD) that are fitted to the permeate tube on either side of the spiral winding and each abut the respective end face of the spiral winding, where the axial stops are provided with axially fluid-permeable passages;
a metallic, hollow cylindrical outer tube that extends coaxially with respect to the permeate tube, surrounds the spiral winding and is joined to the two axial stops;
wherein at least one of the two axial stops has a sleeve-shaped extension which, at its circumference, is surrounded by the outer tube such that a force-fitting and/or form-fitting connection is implemented between the outer tube and the axial stop via the extension thereof,
wherein the force-fitting and/or form-fitting connection is a press-fit connection,
wherein a rectangular foil disposed between the spiral winding and outer tube is disposed and is positioned around the spiral winding such that the spiral winding is completely surrounded by the foil at its circumference, and
wherein the sleeve-shaped extension is adhesively bonded to the foil on its inside.

10. The spiral-wound module according to claim 9, wherein the foil overlaps itself in an overlap region and where the foil is adhesively bonded to itself in the overlap region.

11. The spiral-wound module according to claim 9, wherein the foil consists of a material selected from the group consisting of metal, metal alloy, steel, aluminium alloy, and copper alloy.

12. The spiral-wound module according to claim 9, wherein the foil consists of a material selected from the group consisting of thermally stable polymers.

13. The spiral-wound module according to claim 12, wherein the thermally stable polymer is polyimide.

14. The spiral-wound module according to claim 9, wherein the sleeve-shaped extension is adhesively bonded to the spiral winding on its inside.
